(19) United States
(12) Patent Application Publication
(10) Pub. No.: US 2025/0198310 A1
(43) Pub. Date: Jun. 19, 2025

(54) TURBINE

(71) Applicant: IHI Corporation, Tokyo (JP)

(72) Inventor: Takuro KIRIAKI, Tokyo (JP)

(73) Assignee: IHI Corporation, Tokyo (JP)

(21) Appl. No.: 19/071,859

(22) Filed: Mar. 6, 2025

Related U.S. Application Data
(63) Continuation of application No. PCT/JP2023/022643, filed on Jun. 19, 2023.

(30) Foreign Application Priority Data
Nov. 2, 2022 (JP) 2022-176675

(51) Int. Cl. F01D 25/24

(52) U.S. Cl. CPC F01D 25/24; F05D 2240/14; F05D 2250/52; F05D 2250/75

(57) ABSTRACT

The turbine includes an impeller and a housing that includes a housing outlet, a first scroll flow path, and a second scroll flow path that is located closer to the housing outlet with respect to the first scroll flow path in a central axis direction. In a cross-section that is parallel to and includes a central axis, the second scroll flow path is inclined with respect to the radial direction so as to be spaced apart from the housing outlet in the central axis direction as the second scroll flow path approaches the impeller in the radial direction. In the cross-section, an area including an outlet of the second scroll flow path includes a first portion that has a linear shape parallel to the radial direction and a second portion that has an R shape and that is formed continuously with a radially outer part of the first portion.

### CROSS REFERENCE TO RELATED APPLICATIONS

This application is a continuation application of International Application No. PCT/JP2023/022643, filed on Jun. 19, 2023, which claims priority to Japanese Patent Application No. 2022-176675 filed on Nov. 2, 2022, the entire contents of which are incorporated herein by reference.

### BACKGROUND ART

### Technical Field

The present disclosure relates to a turbine.

A turbine may have two scroll flow paths arranged along a central axis direction of an impeller. For example, Patent Literature 1 discloses a twin scroll turbocharger including such a turbine. In Patent Literature 1, turbocharging efficiency is improved by adjusting a shape of an outlet portion of a front scroll.

### CITATION LIST

### Patent Literature

Patent Literature 1: JP 2013-136993 A

### SUMMARY

### Technical Problem

In this technical field, there is a demand for further improving turbine efficiency.

The purpose of the present disclosure is to provide a turbine that can improve turbine efficiency.

### Solution to Problem

In order to solve the above problem, a turbine according to one aspect of the present disclosure includes an impeller and a housing that accommodates the impeller, the housing including a housing outlet that is spaced apart from the impeller in a central axis direction of the impeller and that discharges fluid that has passed through the impeller, a first scroll flow path that is located outside the impeller in a radial direction of the impeller and that leads fluid to the impeller, and a second scroll flow path that is located outside the impeller in the radial direction and closer to the housing outlet with respect to the first scroll flow path in the central axis direction and that leads fluid to the impeller, the second scroll flow path being inclined with respect to the radial direction in a cross-section that is parallel to and includes a central axis of the impeller so that the second scroll flow path is spaced apart from the housing outlet in the central axis direction as the second scroll flow path approaches the impeller in the radial direction, an area that includes an outlet of the second scroll flow path including, in the above-mentioned cross-section, a first portion that has a linear shape parallel to the radial direction and a second portion that has an R shape and that is formed continuously with a radially outer part of the first portion.

The first portion and the second portion may have cast surfaces.

The first scroll flow path and the second scroll flow path may be directly connected to a space that accommodates the impeller.

### Effects

According to the present disclosure, turbine efficiency can be improved.

### BRIEF DESCRIPTION OF DRAWINGS

FIG. 1 is a schematic cross-sectional view of a turbocharger including a turbine according to an embodiment.

FIG. 2 is an enlarged cross-sectional view showing area A in FIG. 1.

FIG. 3 is an enlarged cross-sectional view showing a turbine according to a first comparative example.

FIG. 4 is an enlarged cross-sectional view showing a turbine according to a second comparative example.

FIG. 5A shows an enlarged cross-sectional view showing result of analysis of entropy of the turbine according to the first comparative example.

FIG. 5B shows an enlarged cross-sectional view showing result of analysis of entropy of the turbine according to the second comparative example.

FIG. 5C shows an enlarged cross-sectional view showing result of analysis of entropy of the turbine according to the embodiment.

FIG. 6 is a graph showing results of analyses of turbine efficiency of the turbines according to the embodiment, the first comparative example, and the second comparative example.

### DESCRIPTION OF EMBODIMENTS

An embodiment of the present disclosure will be described in detail below with reference to the accompanying drawings. Specific dimensions, materials, and numerical values described in the embodiments are merely examples for a better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

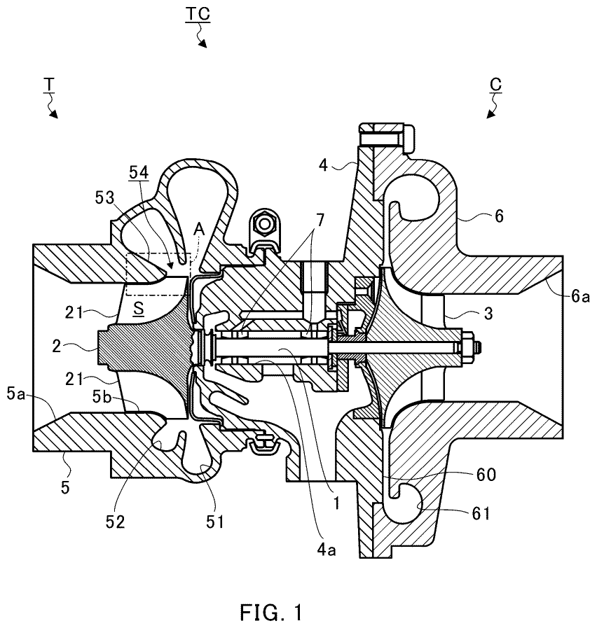

FIG. 1 is a schematic cross-sectional view of a turbocharger TC including a turbine T according to an embodiment. FIG. 1 shows a cross-section that is parallel to a central axis of a shaft 1, a turbine impeller 2 and a compressor impeller 3 and that includes the central axis. In present embodiment, the turbine T is incorporated into the turbocharger TC. In another embodiment, the turbine T may be incorporated into a device other than the turbocharger TC, or may be a standalone unit.

The turbocharger TC includes the shaft 1, the turbine impeller (impeller) 2, and the compressor impeller 3. As will be described later, the shaft 1, the turbine impeller 2, and the compressor impeller 3 rotate integrally. Accordingly, in the present disclosure, a “central axis direction,” a “radial direction” and a “circumferential direction” of the shaft 1, the turbine impeller 2 and compressor impeller 3 may simply be referred to as the “central axis direction,” the “radial direction” and the “circumferential direction,” respectively.

The turbocharger TC includes a bearing housing 4, a turbine housing (housing) 5, and a compressor housing 6. The turbine housing 5 is connected to a first end face (left end face in FIG. 1) of the bearing housing 4 in the central axis direction. The compressor housing 6 is connected to a second end face (right end face in FIG. 1) of the bearing housing 4 in the central axis direction.

The bearing housing 4 includes a bearing hole 4a. The bearing hole 4a extends within the bearing housing 4 in the central axis direction. The bearing hole 4a accommodates a bearing 7. In the present embodiment, two full floating bearings that are arranged spaced apart from each other in the center axis direction are shown as an example of the bearing 7. In another embodiment, the bearing 7 may be other radial bearing such as a semi-floating bearing or a rolling bearing. The bearing 7 rotatably supports the shaft 1.

The turbine impeller 2 is provided at a first end (left end in FIG. 1) of the shaft 1 in the central axis direction. The turbine impeller 2 rotates integrally with the shaft 1. The turbine impeller 2 is rotatably accommodated in the turbine housing 5.

The compressor impeller 3 is provided at a second end (right end in FIG. 1) that is opposite to the first end in the central axis direction in the shaft 1. The compressor impeller 3 rotates integrally with the shaft 1. The compressor impeller 3 is rotatably accommodated in the compressor housing 6.

The compressor housing 6 includes an intake opening 6a on an end face that is opposite to the bearing housing 4 in the central axis direction. The intake opening 6a is spaced apart from the compressor impeller 3 in the central axis direction. The intake opening 6a is connected to an air cleaner (not shown).

The bearing housing 4 and the compressor housing 6 define a diffuser flow path 60 therebetween. The diffuser flow path 60 has an annular shape around the compressor impeller 3. The diffuser flow path 60 is fluidly connected to the intake opening 6a via the compressor impeller 3.

The compressor housing 6 includes a scroll flow path 61. The scroll flow path 61 is located radially outside the diffuser flow path 60. The scroll flow path 61 is fluidly connected to the diffuser flow path 60. Furthermore, the scroll flow path 61 is fluidly connected to an intake port of an engine (not shown). The scroll flow path 61 has a substantially spiral shape.

In the compressor housing 6 as described above, when the compressor impeller 3 rotates, air is sucked into the compressor housing 6 through the intake opening 6a. The air is accelerated and pressurized by centrifugal force when passing through the compressor impeller 3. The air is further pressurized in the diffuser flow path 60 and the scroll flow path 61. The pressurized air flows out of an outlet (not shown), and is led to the intake port of the engine. In the turbocharger TC, a part including the compressor impeller 3 and the compressor housing 6 functions as a centrifugal compressor C.

The turbine housing 5 includes an exhaust opening (housing outlet) 5a on an end face that is opposite to the bearing housing 4 in the central axis direction. The exhaust opening 5a is spaced apart from the turbine impeller 2 in the central axis direction. The exhaust opening 5a is connected to an exhaust gas purifier (not shown).

The turbine housing 5 includes a space S that accommodates the turbine impeller 2. Specifically, the turbine housing 5 includes a shroud 5b that faces blades 21 of the turbine impeller 2. The shroud 5b faces radially inward and defines at least a part of the space S. The space S is fluidly connected to the exhaust opening 5a.

The turbine housing 5 includes a first scroll flow path 51 and a second scroll flow path 52 that are arranged along the central axis direction. Such a turbine T may also be referred to as a “twin scroll turbine.” The first scroll flow path 51 and the second scroll flow path 52 are located radially outside the turbine impeller 2 and the space S. The second scroll flow path 52 is located closer to the exhaust opening 5a with respect to the first scroll flow path 51 in the central axis direction. The first scroll flow path 51 and the second scroll flow path 52 have a substantially spiral shape. The first scroll flow path 51 and the second scroll flow path 52 are fluidly connected to an inlet that is connected to an exhaust port of the engine (not shown). The first scroll flow path 51 and the second scroll flow path 52 receive exhaust gas from the engine. The first scroll flow path 51 and the second scroll flow path 52 are connected to the space S in parallel with each other.

In the present embodiment, there are no vanes between the turbine impeller 2 and the first and second scroll flow paths 51 and 52 for adjusting a flow of the exhaust gas. In other words, the first scroll flow path 51 and the second scroll flow path 52 are directly connected to the space S. Accordingly, in the present embodiment, each of the first scroll flow path 51 and the second scroll flow path 52 directly faces the turbine impeller 2 in the radial direction.

For example, in the cross-section of FIG. 1, the first scroll flow path 51 extends in a direction generally parallel to the radial direction. In the cross-section of FIG. 1, the second scroll flow path 52 is inclined with respect to the radial direction so as to be spaced apart from the exhaust opening 5a in the central axis direction as the second scroll flow path approaches the turbine impeller 2 in the radial direction.

As described above, the exhaust gas from the engine is received by the first scroll flow path 51 and the second scroll flow path 52. The exhaust gas is led to the turbine impeller 2 by the first scroll flow path 51 and the second scroll flow path 52, and is further led to the exhaust opening 5a. The exhaust gas rotates the turbine impeller 2 while passing through the turbine impeller 2. A rotational force of the turbine impeller 2 is transmitted to the compressor impeller 3 via the shaft 1. When the compressor impeller 3 rotates, air is sucked into the intake opening 6a, and accelerated and pressurized by the compressor impeller 3 as described above. In the turbocharger TC, a part including the turbine impeller 2 and the turbine housing 5 functions as the turbine T.

Next, an area including an outlet 54 of the second scroll flow path 52 is described in detail below.

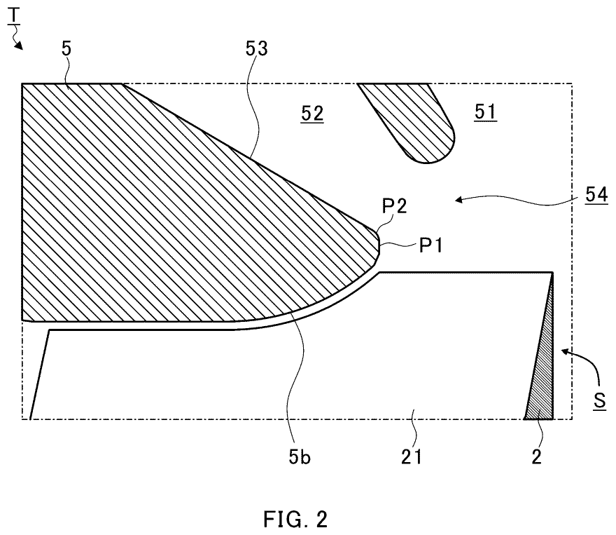

FIG. 2 is an enlarged cross-sectional view showing area A in FIG. 1, showing an area including the outlet 54 of the second scroll flow path 52. In the second scroll flow path 52, the outlet 54 is a section that is closest to the space S. As similar to FIG. 1, FIG. 2 shows the cross-section that is parallel to and that includes the center axis of the turbine impeller 2.

The second scroll flow path 52 includes a surface 53 that is connected to the shroud 5b. The surface 53 faces radially outward. In the cross-section of FIG. 2, the area including the outlet 54 of the second scroll flow path 52 includes a first portion P1 and a second portion P2. From another perspective, the first portion P1 and the second portion P2 are located between the surface 53 and the shroud 5b, and the surface 53 and the shroud 5b are connected to each other via the first portion P1 and the second portion P2.

The first portion P1 has a linear shape parallel to the radial direction in the cross-section of FIG. 2. The first portion P1 is located radially outside the shroud 5b. The first portion P1 is formed continuously with the shroud 5b.

The second portion P2 has an R shape in the cross-section of FIG. 2. Accordingly, the second portion P2 has a round shape (arc shape). The second portion P2 is located radially outside the first portion P1. The second portion P2 is formed continuously with the first portion P1.

For example, the turbine housing 5 including the first portion P1 and the second portion P2 can be manufactured as follows. First, the turbine housing 5 is formed by casting. For example, the first scroll flow path 51 and the second scroll flow path 52 can be formed using cores. Next, the shroud 5b is finished by machining. During machining, the first portion P1 and the second portion P2 are not machined. Accordingly, the first portion P1 and the second portion P2 of the turbine housing 5 as a finished product have cast surfaces. For example, if the first portion P1 and the second portion P2 are machined, the boundary between the second portion P2 and an area within the second scroll flow path 52 is difficult to be machined smoothly. Such difficult machining increases manufacturing costs. However, in the present embodiment, such machining is not required because the first portion P1 and the second portion P2 are left as cast surfaces. In addition, according to such a configuration, for example, the first portion P1 including the linear shape can be used as a reference for subsequent machining.

In the turbine T as described above, a direction of a flow of the exhaust gas flowing through the second scroll flow path 52 is reversed in the central axis direction, when flowing into the space S. In particular, in the present embodiment, since the second scroll flow path 52 is directly connected to the space S, the flow of the exhaust gas is sharply curved when flowing into the space S. Accordingly, the flow along the surface 53 is likely to separate from an area along the shroud 5b after the direction of the flow is reversed. However, in the present embodiment, the area including the outlet 54 includes the second portion P2 having the R shape and the first portion P1 having the linear shape along the flow of the exhaust gas. Accordingly, the direction of the flow along the surface 53 is reversed while passing through the second portion P2 and the first portion P1, so that the flow along the surface 53 is more likely to follow other flows. As a result, a separation in the area along the shroud 5b is curbed, compared to the case where one of or both of the R shape and the linear shape are not present, for example.

Next, results of analyses of the area including the outlet 54 of the second scroll flow path 52 will be explained.

CFD (Computational Fluid Dynamics) analysis was conducted with using a model similar to the turbine T shown in FIGS. 1 and 2. The same analyses were also conducted with using models of comparative examples.

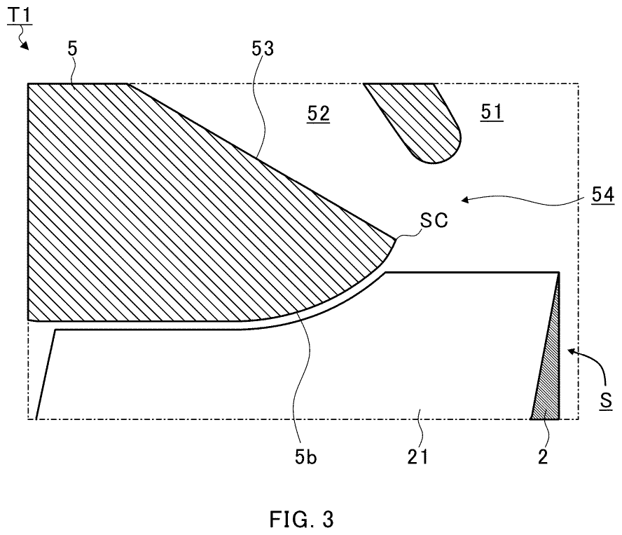

FIG. 3 is an enlarged cross-sectional view showing a turbine T1 according to a first comparative example. The turbine T1 differs from the turbine T of the above embodiment in the shape of the area including the outlet 54. For other configurations, the turbine T1 may be the same as the turbine T.

In the turbine T1, the turbine housing 5 does not include the above-described first portion P1 and second portion P2. The surface 53 and the shroud 5b are directly connected to each other by a sharp corner SC.

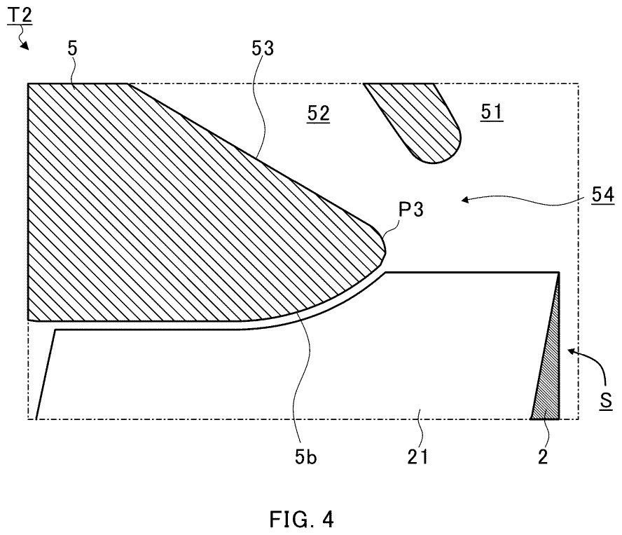

FIG. 4 is an enlarged cross-sectional view showing a turbine T2 according to a second comparative example. The turbine T2 differs from the turbine T of the above embodiment in the shape of the area including the outlet 54. For other configurations, the turbine T2 may be the same as the turbine T.

In the turbine T2, the turbine housing 5 includes a third portion P3 instead of the above-described first portion P1 and second portion P2. The third portion P3 has an R-shape. In other words, only the third portion P3 including the R-shape is located between the surface 53 and the shroud 5b in the turbine T2. For example, the radius of the R-shape of the third portion P3 is larger than the radius of the R-shape of the above-described second portion P2.

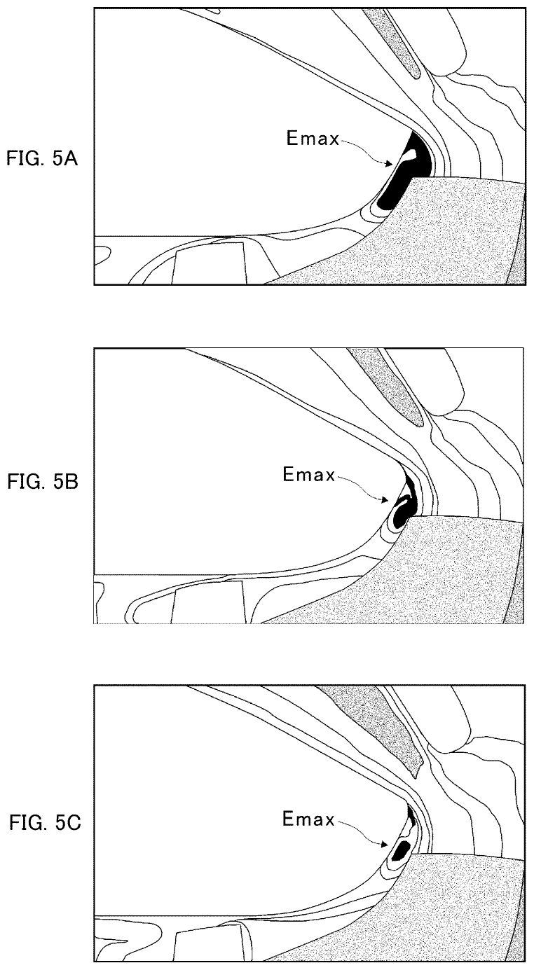

FIG. 5A shows an enlarged cross-sectional view showing result of analysis of entropy of the turbine T1 according to the first comparative example, FIG. 5B shows an enlarged cross-sectional view showing result of analysis of entropy of the turbine T2 according to the second comparative example, and FIG. 5C shows an enlarged cross-sectional view showing result of analysis of entropy of the turbine T according to the embodiment. The same conditions were used in the analyses, except for the shape of the area including the outlet 54.

As shown in FIGS. 5A, 5B and 5C, an area Emax with high entropy (black area) in the area along the shroud 5b decreases in the order of the turbine T1, the turbine T2 and the turbine T. In other words, the area along the shroud 5b in the turbine T of the embodiment has the least amount of separation.

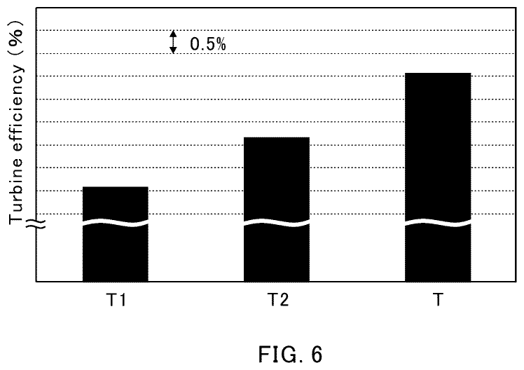

FIG. 6 is a graph showing results of analyses of turbine efficiency of the turbines T1, T2 and T according to the first comparative example, the second comparative example, and the embodiment. FIG. 6 shows turbine efficiency of each model in the results of analyses of FIGS. 5A, 5B and 5C. For example, turbine efficiency can be calculated by dividing output of a turbine by the amount of heat supplied to the turbine.

As shown in FIG. 6, the turbine efficiency increases in the order of the turbine T1, the turbine T2, and the turbine T, following the reduction in the separation. As such, the turbine efficiency can be improved according to the turbine T of the embodiment.

The turbine T as described above includes the turbine impeller 2 and the turbine housing 5 that accommodates the turbine impeller 2. The turbine housing 5 includes the exhaust opening 5a that is spaced apart from the turbine impeller 2 in the central axis direction and that discharges the exhaust gas that has passed through the turbine impeller 2, the first scroll flow path 51 that is located outside the turbine impeller 2 in the radial direction and that leads the exhaust gas to the turbine impeller 2, and the second scroll flow path 52 that is located outside the turbine impeller 2 in the radial direction and closer to the exhaust opening 5a with respect to the first scroll flow path 51 in the central axis direction and that leads fluid to the turbine impeller 2. In the cross-section that is parallel to and includes the central axis, the second scroll flow path 52 is inclined with respect to the radial direction so that the second scroll flow path is spaced apart from the exhaust opening 5a in the central axis direction as the second scroll flow path approaches the turbine impeller 2 in the radial direction. Furthermore, in the above-described cross-section, the area that includes the outlet 54 of the second scroll flow path 52 includes the first portion P1 that has a linear shape parallel to the radial direction and the second portion P2 that has the R shape and that is formed continuously with a radially outer part of the first portion P1. According to such a configuration, since the direction of the flow along the surface 53 is reversed while passing through the second portion P2 and the first portion P1, the flow along the surface 53 is more likely to follow other flows. Accordingly, a separation in the area along the shroud 5b is curbed, compared to the case where one of or both of the R shape and the linear shape are not present, for example. As a result, turbine efficiency can be improved.

Furthermore, in the turbine T, the first portion P1 and the second portion P2 have cast surfaces. According to such a configuration, the first portion P1 having the linear shape can be used as a reference for subsequent machining. In addition, difficult machining is not required.

Furthermore, in the turbine T, the first scroll flow path 51 and the second scroll flow path 52 are directly connected to the space S that accommodates the turbine impeller 2. According to such a configuration, the exhaust gas flowing through the second scroll flow path 52 is sharply reversed when flowing into the space S. Accordingly, the effect of curbing the separation is more likely to be exhibited.

Although an embodiment of the present disclosure has been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

For example, in the above embodiment, the turbine T does not include vanes for adjusting the flow of the exhaust gas between the turbine impeller 2 and the first and second scroll flow paths 51 and 52. However, in another embodiment, the turbine may include such vanes.

What is claimed is:

1. A turbine comprising:
an impeller; and
a housing that accommodates the impeller, the housing including:
a housing outlet that is spaced apart from the impeller in a central axis direction of the impeller and that discharges fluid that has passed through the impeller;
a first scroll flow path that is located outside the impeller in a radial direction of the impeller and that leads fluid to the impeller; and
a second scroll flow path that is located outside the impeller in the radial direction and closer to the housing outlet with respect to the first scroll flow path in the central axis direction and that leads fluid to the impeller, the second scroll flow path being inclined with respect to the radial direction in a cross-section that is parallel to and includes a central axis of the impeller so that the second scroll flow path is spaced apart from the housing outlet in the central axis direction as the second scroll flow path approaches the impeller in the radial direction, an area that includes an outlet of the second scroll flow path including, in the cross-section, a first portion that has a linear shape parallel to the radial direction and a second portion that has an R shape and that is formed continuously with a radially outer part of the first portion.

2. The turbine according to claim 1, wherein the first portion and the second portion have cast surfaces.

3. The turbine according to claim 1, wherein the first scroll flow path and the second scroll flow path are directly connected to a space that accommodates the impeller.
